(19) United States
(12) Patent Application Publication
(10) Pub. No.: US 2026/0269279 A1
(43) Pub. Date: Sep. 10, 2026

(54) METAL SEPARATOR

(71) Applicant: Hyundai Steel Company, Incheo (KR)

(72) Inventors: Kun Ho Kim, Incheo (KR); Jun Hee Han, Incheo (KR); Kwang Seo Park, Incheo (KR); Hyun Uk Im, Incheo (KR); Min Ha Kim, Incheo (KR); Yeon Soo Jeong, Incheo (KR)

(21) Appl. No.: 19/489,572

(22) PCT Filed: Sep. 12, 2024
(86) PCT No.: PCT/KR2024/013940

§ 371 Date: Dec. 2, 2025

(30) Foreign Application Priority Data
Sep. 12, 2023 (KR) 10-2023-0121400
Sep. 10, 2024 (KR) 10-2024-0123496

(51) Int. Cl. H01M 8/021; H01M 8/0228; H01M 8/0258; H01M 8/0276; H01M 8/0284; H01M 8/1004

(52) U.S. Cl. CPC H01M 8/021; H01M 8/0228; H01M 8/0258; H01M 8/0276; H01M 8/0284; H01M 8/1004

(57) ABSTRACT

The present application relates to a metal separator, a fuel cell comprising the metal separator, and a fuel cell stack comprising the fuel cell. According to the metal separator of the present application, it is possible to secure airtightness while preventing deformation of manifold inlet-and-outlet holes, and to uniformly distribute the flow rate of an injected and discharged reaction gas.

### TECHNICAL FIELD

The present application relates to a metal separator, a fuel cell including the metal separator, and a fuel cell stack including the fuel cell.

### BACKGROUND

In recent years, powertrains have been shifting from internal combustion engines (ICEs) to electric vehicles (EVs) or hydrogen fuel cell electric vehicles (FCEVs) in order to deal with global warming. Fuel cells used in hydrogen fuel cell electric vehicles (FCEVs) not only supply driving power for industry, households, and vehicles, but also are used for power supply to small electronic products such as portable devices, and the scope of their use is gradually expanding as a highly efficient clean energy source in terms of both energy conservation and environmental measures.

A hydrogen fuel cell is a kind of electric power generation device that converts the chemical energy held by fuel into electrical energy through electrochemical reactions in a stack, and generates electricity by using the energy produced during the binding reaction of hydrogen and oxygen. Specifically, hydrogen fuel cells can use hydrogen gas as fuel, and the oxidation reaction of the hydrogen gas can proceed and thus generate hydrogen ions (protons) and electrons. The hydrogen ions and electrons generated at this time cause an electrochemical reaction with oxygen in the air to produce water, and at the same time, electrical energy is generated from the flow of electrons.

These hydrogen fuel cells consist of a metal separator, a gas diffusion layer (GDL), and a membrane electrode assembly. In particular, of these components, the metal separator is a core component constituting a fuel cell stack, along with the gas diffusion layer and membrane electrode assembly, and serves to separate hydrogen, oxygen, and cooling water, respectively, to distribute and supply them uniformly over the entire surface of the membrane electrode assembly, and to collect (anode) and transmit (cathode) the current generated by the electrochemical reaction.

The metal separator has gasket lines formed on its surface in order to maintain airtightness so that the hydrogen, oxygen, and cooling water flowing through the flow paths do not leak out to other areas. However, the metal separator is a sheet whose material is very thin, and there are problems where deformation occurs in the manifold inlet and outlet holes of the metal separator due to the pressure applied when stacking multiple cells if the gasket lines are not optimized, or gaps are formed in the middle of the sub-gasket lines if the sub-gasket lines are not pressed relatively densely. If deformation occurs in the manifold inlet and outlet holes or gaps are formed in the middle of the sub-gasket lines, there arises a problem of difficulty in ensuring airtightness. Therefore, in order to solve such a problem, there is a need for a metal separator with a gasket shape that can prevent the deformation of the manifold inlet and outlet holes and simultaneously ensure airtightness.

### SUMMARY

### Technical Objects

It is an object of the present application to provide a metal separator that can prevent the deformation of the manifold inlet and outlet holes and simultaneously ensure airtightness, and uniformly distribute the flow rates of injected and discharged reaction gases.

### Technical Solution

In order to achieve the above object, a metal separator of the present application includes a metal separator body and gasket lines formed on a surface of one or more faces of the metal separator body, wherein the metal separator body includes a reaction surface including a reaction flow path, a cooling surface located opposite the reaction surface and including a cooling flow path, a manifold part including one or more pairs of first reaction gas manifolds, one or more pairs of cooling water manifolds, and one or more pairs of second reaction gas manifolds formed by passing through the reaction surface and the cooling surface on both sides of each of the reaction flow path and the cooling flow path, and a plurality of manifold inlet and outlet holes formed by passing through the reaction surface and the cooling surface between the one or more pairs of second reaction gas manifolds and each of the reaction flow path and the cooling flow path, wherein the gasket lines include manifold gasket lines respectively surrounding an entire perimeter of each of the one or more pairs of first reaction gas manifolds, the one or more pairs of cooling water manifolds, and the one or more pairs of second reaction gas manifolds, or respectively surrounding an entire perimeter of each of the one or more pairs of first reaction gas manifolds and the one or more pairs of second reaction gas manifolds, flow path gasket lines connected to the manifold gasket lines and surrounding the reaction flow path and the plurality of manifold inlet and outlet holes or surrounding the cooling flow path and the one or more pairs of cooling water manifolds, and a plurality of support gasket lines extending from the manifold gasket lines located on an inner perimeter of each of the one or more pairs of second reaction gas manifolds toward the reaction flow path or each of the one or more pairs of second reaction gas manifolds and formed between the plurality of manifold inlet and outlet holes, and wherein the support gasket lines satisfy General Formula 1 below:

$$( B - ( B \times 0.5 ) ) 2 \leq D \leq ( B + ( B \times 0.5 ) ) 2 \qquad [ General Formula 1 ]$$

where, in General Formula 1 above, D is the length of the gasket line, and B is the width of the manifold gasket line.

The manifold gasket lines may have a width of 2 mm to 5 mm.

Furthermore, the gasket lines may contain fluorocarbon rubber (FKM), ethylene propylene diene terpolymer (EPDM), or vinyl methyl silicone rubber (LSR).

Moreover, the plurality of support gasket lines may extend from the manifold gasket lines located on an inner perimeter of each of the one or more pairs of first reaction gas manifolds toward the reaction flow path or each of the one or more pairs of first reaction gas manifolds, thereby forming an additional plurality.

In addition, the gasket lines may be formed on the surfaces of the reaction surface and the cooling surface of the metal separator body, or may be formed on the surface of the reaction surface of the metal separator body but not on the surface of the cooling surface.

Furthermore, the metal separator body may be a base material made of stainless steel, titanium, aluminum, magnesium, or an alloy thereof.

Moreover, the metal separator body may further include diffusion flow paths connected to each of the reaction flow path and the cooling flow path and extending toward the plurality of manifold inlet and outlet holes.

In addition, the metal separator may further include a metal coating layer or surface modification layer formed on a surface of the metal separator body or on a surface of the metal separator body on which the gasket lines are formed.

Furthermore, a fuel cell of the present application incudes a membrane electrode assembly whose outer periphery is surrounded by sub-gasket lines, and a pair of the metal separators stacked, respectively, such that the sub-gasket lines come in contact with the support gasket lines and the reaction surfaces face lower and upper portions of the membrane electrode assembly.

Moreover, the metal separator disposed below the membrane electrode assembly may be a hydrogen electrode metal separator, and the metal separator disposed above the membrane electrode assembly may be an air electrode metal separator.

In addition, the hydrogen electrode metal separator may have the gasket lines formed on the surface of the reaction surface of the metal separator body but no gasket lines formed on the surface of the cooling surface, or may have the gasket lines formed on the surfaces of the reaction surface and the cooling surface of the metal separator body, and the air electrode metal separator may have the gasket lines formed on the surfaces of the reaction surface and the cooling surface of the metal separator body, or may have the gasket lines formed on the surface of the reaction surface of the metal separator body but no gasket lines formed on the surface of the cooling surface. Furthermore, a fuel cell stack of the present application includes the fuel cell as a unit cell.

### Effects of the Disclosure

The present application relates to a metal separator, a fuel cell including the metal separator, and a fuel cell stack including the fuel cell. According to the metal separator of the present application, the deformation of the manifold inlet and outlet holes can be prevented, airtightness can be ensured at the same time, and the flow rates of the injected and discharged reaction gases can be uniformly distributed.

### BRIEF DESCRIPTION OF THE DRAWINGS

FIG. 1 is a top view showing, by way of example, a reaction surface of a hydrogen electrode metal separator in accordance with one embodiment of the present application;

FIG. 2 is a top view showing, by way of example, a cooling surface of the hydrogen electrode metal separator in accordance with one embodiment of the present application;

FIG. 3 is a top view showing, by way of example, a reaction surface of an air electrode metal separator in accordance with one embodiment of the present application;

FIG. 4 is a top view showing, by way of example, a cooling surface of the air electrode metal separator in accordance with one embodiment of the present application;

FIG. 5 is a top view enlarging and showing, by way of example, some areas in order to describe support gasket lines of the metal separator in accordance with one embodiment of the present application;

FIG. 6 is a side view showing, by way of example, a fuel cell in accordance with one embodiment of the present application; and

FIG. 7 is a top view showing, by way of example, a fuel cell before metal separators are stacked according to one embodiment of the present application.

### BEST MODE FOR CARRYING OUT THE INVENTION

Hereinafter, a metal separator of the present application will be described with reference to the accompanying drawings, the accompanying drawings are illustrative, and the metal separator of the present application is not limited to the accompanying drawings.

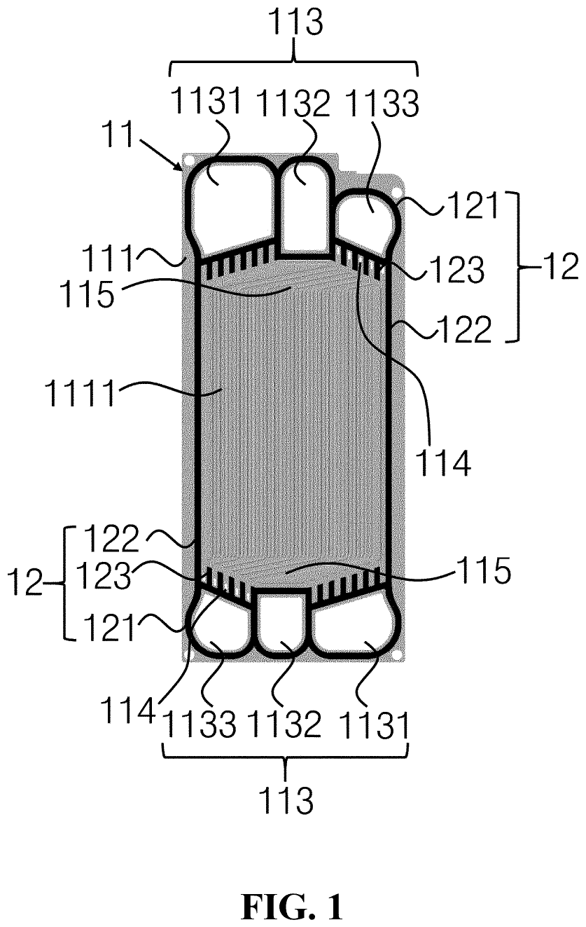

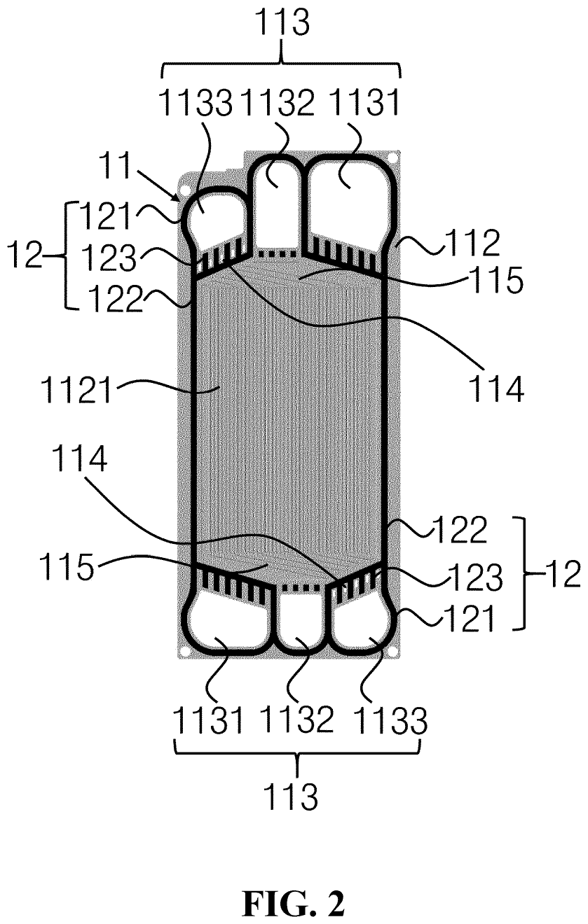

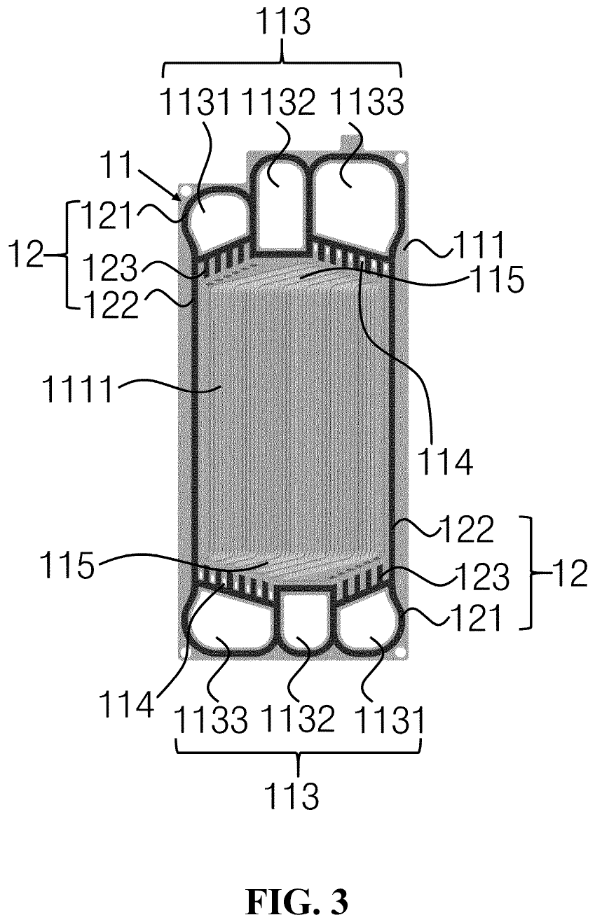

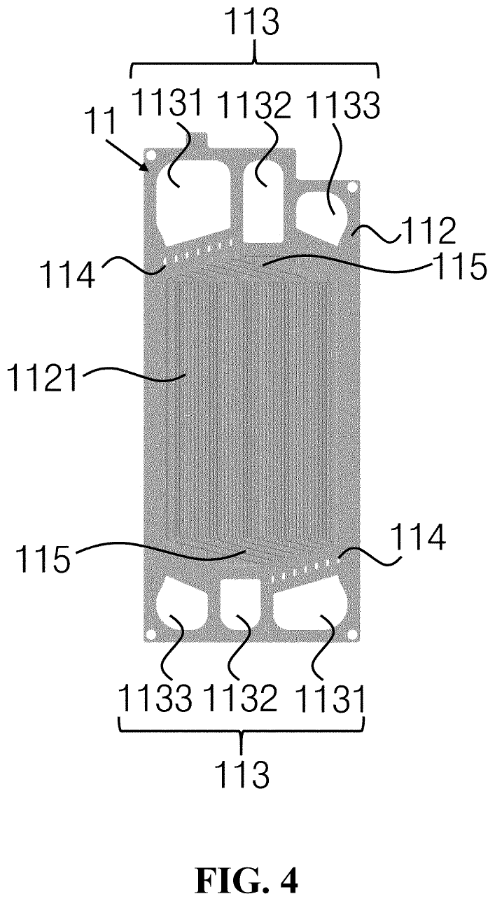

FIG. 1 is a top view showing, by way of example, a reaction surface of a hydrogen electrode metal separator in accordance with one embodiment of the present application. FIG. 2 is a top view showing, by way of example, a cooling surface of the hydrogen electrode metal separator in accordance with one embodiment of the present application. FIG. 3 is a top view showing, by way of example, a reaction surface of an air electrode metal separator in accordance with one embodiment of the present application. FIG. 4 is a top view showing, by way of example, a cooling surface of the air electrode metal separator in accordance with one embodiment of the present application. As shown in FIGS. 1 to 4, the metal separator of the present application includes a metal separator body 11 and gasket lines 12. According to the metal separator of the present application, the deformation of manifold inlet and outlet holes 114 can be prevented, airtightness can be ensured at the same time, and the flow rates of injected and discharged reaction gases can be uniformly distributed.

The metal separator body 11 is a main component used in a metal separator for a fuel cell, and includes a reaction surface 111, a cooling surface 112, a manifold part 113, and manifold inlet and outlet holes 114.

In one example, the type of the metal separator body 11 is not particularly limited, and any metal base material used in metal separators for fuel cells may be used without limitation. For example, a base material made of stainless steel, titanium, aluminum, magnesium, or an alloy thereof may be used as the metal separator body 11. Specifically, STS 300 series such as STS 316L, STS 400 series such as STS 443CT or STS 470FC, or the like, which are base materials made of stainless steel, may be used, or Grade 1 or the like, which is a base material made of titanium, may also be used, as the metal base material. By using the metal base material described above as the metal separator body 11, the metal separator can have excellent electrical conductivity and corrosion resistance.

The reaction surface 111 is a portion where electrochemical reactions occur by the reaction gases supplied and discharged, respectively, through the metal separator, is provided on one side of the metal separator body 11, and includes a reaction flow path 1111 located centrally with respect to the flow direction of the reaction gases. The “flow direction of the reaction gases” herein refers to the direction in which the reaction gases flow along the reaction flow path 1111, and may be, for example, the same as the longitudinal direction of the metal separator body 11.

The reaction flow path 1111 includes a plurality of flow path sections formed by extending along the flow direction of the reaction gases.

In one example, the height of the reaction flow path 1111 may be 0.20 mm to 0.60 mm, and specifically, may be 0.30 mm to 0.55 mm or 0.40 mm to 0.50 mm. In this case, the height of the reaction flow path 1111 refers to the length obtained by measuring the portion protruding along the thickness direction inside the reaction flow path 1111. The reaction flow path 1111 can exhibit excellent reaction gas supply properties by having the height described above.

In addition, the pitch between the plurality of flow path sections may be 0.5 mm to 2.0 mm, and specifically, may be 0.8 mm to 1.6 mm or 1.0 mm to 1.2 mm. By ensuring that the pitch between the plurality of flow path sections satisfies the range described above, the performance of the fuel cell can be maximized.

The cooling surface 112 is a portion through which cooling water for removing heat generated by the electrochemical reactions of the reaction gases on the reaction surface 111 flows, is located opposite the reaction surface 111 provided on the metal separator body 11, and includes a cooling flow path 1121 located centrally with respect to the flow direction of the cooling water. The “flow direction of the cooling water” herein refers to the direction in which the cooling water flows along the cooling flow path 1121, and may be, for example, the same as the longitudinal direction of the metal separator body 11.

The cooling flow path 1121 includes a plurality of flow path sections formed by extending along the flow direction of the cooling water.

In one example, the height of the cooling flow path 1121 may be 0.20 mm to 0.60 mm, and specifically, may be 0.30 mm to 0.55 mm or 0.40 mm to 0.50 mm. In this case, the height of the cooling flow path 1121 refers to the length obtained by measuring the portion protruding along the thickness direction inside the cooling flow path 1121. The cooling flow path 1121 can exhibit excellent cooling water supply properties by having the height described above.

In addition, the pitch between the plurality of flow path sections may be 0.5 mm to 2.0 mm, and specifically, may be 0.8 mm to 1.6 mm or 1.0 mm to 1.2 mm. By ensuring that the pitch between the plurality of flow path sections satisfies the range described above, the performance of the fuel cell can be maximized.

The manifold part 113 is a portion for supplying and discharging the reaction gases and cooling water for the electrochemical reactions in the metal separator, and includes one or more pairs of first reaction gas manifolds 1131, one or more pairs of cooling water manifolds 1132, and one or more pairs of second reaction gas manifolds 1133, which are formed by passing through the reaction surface 111 and the cooling surface 112 on both sides of each of the reaction flow path 1111 and the cooling flow path 1121. The term “pair” herein means that two portions formed on both sides of each of the reaction flow path and the cooling flow path form a pair. Further, the term “one or more pairs” herein means that portions that perform the same function and are formed in pairs are one or more, and the upper limit thereof is not particularly limited unless otherwise stated.

Specifically, the one or more pairs of first reaction gas manifolds 1131 and the one or more pairs of second reaction gas manifolds 1133 may have injection ports and discharge ports for hydrogen and air for supplying and discharging the reaction gases, respectively, formed therein, and the one or more pairs of cooling water manifolds 1132 may have an injection port and a discharge port for cooling water for adjusting the operating temperature formed therein. In one embodiment, one or more first reaction gas manifolds 1131, one or more cooling water manifolds 1132, and one or more second reaction gas manifolds 1133, which are formed at one end relative to the longitudinal direction of the metal separator body 11, may be arranged on the reaction surface 111 along the width direction perpendicular to the longitudinal direction of the metal separator body 11, and specifically, one or more first reaction gas discharge ports, one or more cooling water discharge ports, and one or more second reaction gas injection ports may be arranged. Further, one or more second reaction gas manifolds 1133, one or more cooling water manifolds 1132, and one or more first reaction gas manifolds 1131, which are formed at the other end relative to the longitudinal direction of the metal separator body 11, may be arranged on the reaction surface 111 along the width direction perpendicular to the longitudinal direction of the metal separator body 11, and specifically, one or more second reaction gas discharge ports, one or more cooling water injection ports, and one or more first reaction gas injection ports may be arranged. That is, the one or more pairs of first reaction gas manifolds 1131 and the one or more pairs of second reaction gas manifolds 1133 may be arranged so that the respective one or more pairs are staggered with respect to one another. In this case, the one or more pairs of first reaction gas manifolds 1131 and the one or more pairs of second reaction gas manifolds 1133 may be arranged on the cooling surface 112 so as to be opposite the reaction surface 111. The term “longitudinal direction of the metal separator body” herein refers to the direction from one end toward the other end of the metal separator body 11. In addition, the term “width direction of the metal separator body” herein refers to the direction perpendicular to the longitudinal direction. In this case, the first reaction gas may be hydrogen or air, and the second reaction gas may be either hydrogen or air, differing from the first reaction gas. In one embodiment, if the metal separator is a hydrogen electrode metal separator, the first reaction gas may be air, and the second reaction gas may be hydrogen. Further, in another embodiment, if the metal separator is an air electrode metal separator, the first reaction gas may be hydrogen, and the second reaction gas may be air.

The manifold inlet and outlet holes 114 are holes that allow the first reaction gas or the second reaction gas supplied through the manifold part 113 to flow into the reaction flow path 1111, specifically, a diffusion flow path 115 described later, or allow the first reaction gas or the second reaction gas passed through the reaction flow path 1111, specifically, the diffusion flow path 115 described later, to flow into the manifold part 113, and are formed in a plurality passing through the reaction surface 111 and the cooling surface 112 between the one or more pairs of second reaction gas manifolds 1133 and each of the reaction flow path 1111 and the cooling flow path 1121. The term “plurality” herein means two or more, and the upper limit thereof is not particularly limited unless otherwise stated.

In one example, the metal separator body 11 may further include diffusion flow paths 115 connected to each of the reaction flow path 1111 and the cooling flow path 1121 and extending to the plurality of manifold inlet and outlet holes 114. The diffusion flow paths 115 are flow paths that distribute the reaction gas, specifically the second reaction gas, flowing in through the plurality of manifold inlet and outlet holes 114 to each of the plurality of flow path sections of the reaction flow path 1111, and then discharge the distributed reaction gas to the plurality of manifold inlet and outlet holes 114, and that distribute the cooling water flowing in through the cooling water manifold 1132 to each of the plurality of flow path sections of the cooling flow path 1121, and then discharge the distributed cooling water to the plurality of manifold inlet and outlet holes 114. That is, the diffusion flow paths 115 may form one or more pairs by being provided respectively between the reaction flow path 1111 and the plurality of manifold inlet and outlet holes 114 adjacent to each of the one or more pairs of second reaction gas manifolds 1133 on the reaction surface 111, and may also form one or more pairs by being provided respectively between the reaction flow path 1111 and the plurality of manifold inlet and outlet holes 114 adjacent to each of the one or more pairs of second reaction gas manifolds 1133 on the cooling surface 112.

The gasket lines 12 are packings formed to ensure airtightness against the first reaction gas, the second reaction gas, and the cooling water flowing in the metal separator body 11 when stacking a fuel cell described later using the metal separator, and are formed on the surface of one or more faces of the metal separator body.

In one example, the gasket lines 12 may be formed on the surfaces of the reaction surface 111 and the cooling surface 112 of the metal separator body 11, or may be formed on the surface of the reaction surface 111 of the metal separator body but not on the surface of the cooling surface 112. Specifically, if the metal separator is a hydrogen electrode metal separator described later, the gasket lines (not shown) may be formed on the surface of the reaction surface (not shown) but not on the surface of the cooling surface (not shown), or may be formed on the surface of the reaction surface 111 and the surface of the cooling surface 112, as shown in FIGS. 1 and 2. In addition, if the metal separator is an air electrode metal separator described later, the gasket lines (not shown) may be formed on the surfaces of the reaction surface (not shown) and the cooling surface (not shown), or may be formed on the surface of the reaction surface 111 but not on the surface of the cooling surface 112, as shown in FIGS. 3 and 4. More specifically, if the gasket lines are formed on the surface of the reaction surface but not on the surface of the cooling surface in the hydrogen electrode metal separator, the gasket lines may be formed on the surfaces of both the reaction surface and the cooling surface in the air electrode metal separator. Further, if the gasket lines 12 are formed on the surface of the reaction surface 111 and the surface of the cooling surface 112 in the hydrogen electrode metal separator, the gasket lines 12 may be formed on the surface of the reaction surface 111 but not on the surface of the cooling surface 112 in the air electrode metal separator.

In one example, the gasket lines 12 may contain fluorocarbon rubber (FKM), ethylene propylene diene terpolymer (EPDM), or vinyl methyl silicone rubber (LSR). Specifically, if the gasket lines 12 contain fluorocarbon rubber (FKM), they can be excellent in material properties such as oxidation resistance and flame retardancy compared to other rubber materials due to its high degree of fluorination, excellent in stability due to the high bond strength between carbon and fluorine, and excellent in productivity and workability as the rate of burr generation is low during operation. The gasket lines 12 can be less expensive and be excellent in cold resistance, water resistance, antifreeze resistance, and resistance to alcohols, ketones, etc., when they contain ethylene propylene diene terpolymer (EPDM). Further, the gasket lines 12 can be excellent in material utilization, productivity, and workability as the rate of burr generation is low during operation, be excellent in low-temperature properties, and be less expensive if they contain vinyl methyl silicone rubber (LSR).

The gasket line 12 includes a manifold gasket line 121, a flow path gasket line 122, and a support gasket line 123.

The manifold gasket lines 121 surround the entire perimeter of each of the one or more pairs of first reaction gas manifolds 1131, the one or more pairs of cooling water manifolds 1132, and the one or more pairs of second reaction gas manifolds 1133, as shown in FIGS. 1 and 3, or surround respectively the entire perimeter of each of the one or more pairs of first reaction gas manifolds 1131 and the one or more pairs of second reaction gas manifolds 1133, as shown in FIG. 2. The description that the gasket line surrounds the entire perimeter herein means that the entire perimeter is surrounded by a single gasket line.

The flow path gasket lines 122 are connected to the manifold gasket lines 121, and surround the reaction flow path 1111 and the plurality of manifold inlet and outlet holes 114 or surround the cooling flow path 1121 and the one or more pairs of cooling water manifolds 1132. In this case, the flow path gasket lines 122 surrounding the reaction flow path 1111 and the plurality of manifold inlet and outlet holes 114 may be connected and integrated with the manifold gasket lines 121 located respectively on both sides of the reaction flow path 1111, and the flow path gasket lines 122 surrounding the cooling flow path 1121 and the plurality of cooling water manifolds 1132 may be connected and integrated with the manifold gasket lines 121 located respectively on both sides of the cooling flow path 1121.

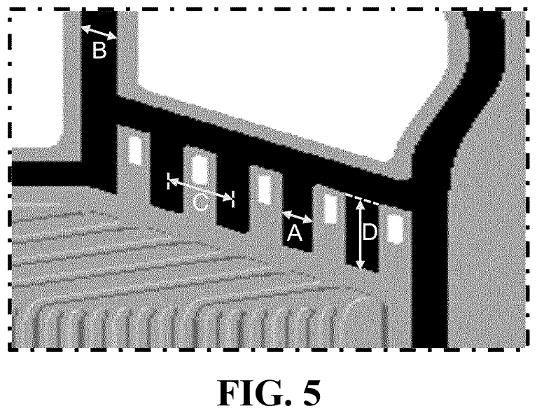

The support gasket lines 123 extend from the manifold gasket lines 121 located on the inner perimeter of each of the one or more pairs of second reaction gas manifolds 1133 toward the reaction flow path 1111 or toward each of the one or more pairs of second reaction gas manifolds 1133, and are formed in a plurality between the plurality of manifold inlet and outlet holes 114. The term “inner perimeter” herein refers to the perimeter located closest to the reaction flow path or cooling flow path of the entire perimeter. Further, the term “extend” herein refers to forming toward a certain direction. By including the support gasket lines 123 described above, the metal separator can prevent the deformation of the manifold inlet and outlet holes 114 and simultaneously ensure airtightness, and uniformly distribute the flow rates of the injected and discharged reaction gases. FIG. 5 is a view enlarging and showing, by way of example, some areas in order to describe support gasket lines of the metal separator in accordance with one embodiment of the present application. As shown in FIG. 5, the support gasket lines 123 satisfy General Formula 1 below:

$$( B - ( B \times 0.5 ) ) 2 \leq D \leq ( B + ( B \times 0.5 ) ) 2 \qquad [ General Formula 1 ]$$

In General Formula 1 above, D denotes the length of the gasket line, and B denotes the width of the manifold gasket line.

That is, the length D of the support gasket line is 1 to 3 times the width B of the manifold gasket line. Specifically, the length D of the support gasket line may be 1.5 to 2.5 times the width B of the manifold gasket line. By ensuring that the length D of the support gasket line satisfies the range described above, the deformation of the manifold inlet and outlet holes 114 can be prevented, airtightness can be ensured at the same time, and the flow rates of the injected and discharged reaction gases can be uniformly distributed. In contrast, if the length D of the support gasket line falls below the lower limit or exceeds the upper limit of the range described above, deformation may occur in the manifold inlet and outlet holes 114, or a gap may form in the middle of the sub-gasket lines and allow the reaction gases and cooling water to flow through the gap, making it difficult to ensure airtightness.

For example, the width B of the manifold gasket line may be 2 mm to 5 mm, and more specifically, the width B of the manifold gasket line may be 3 mm to 4 mm. By ensuring that the width B of the manifold gasket line satisfies the range described above, the deformation of the manifold inlet and outlet holes 114 can be prevented, airtightness can be ensured at the same time, and the flow rates of the injected and discharged reaction gases can be uniformly distributed. In contrast, if the width B of the manifold gasket line falls below the lower limit or exceeds the upper limit of the range described above, deformation may occur in the manifold inlet and outlet holes 114, or a gap may form in the middle of the sub-gasket lines and allow the reaction gases and cooling water to flow through the gap, making it difficult to ensure airtightness.

In another example, the support gasket lines 123 may satisfy General Formula 2 below:

$$( B - ( B \times 02 ) ) 2 \leq C \leq ( B + ( B \times 0.2 ) ) 2 \qquad [ General Formula 2 ]$$

In General Formula 2 above, C is the pitch of the support gasket lines, and B is the width of the manifold gasket line.

That is, the pitch C of the support gasket lines is 1.6 to 2.4 times the width B of the manifold gasket line. Specifically, the pitch C of the support gasket lines may be 1.8 to 2.2 times the width B of the manifold gasket line. By ensuring that the pitch C of the support gasket lines satisfies the range described above, the deformation of the manifold inlet and outlet holes 114 can be prevented, airtightness can be ensured at the same time, and the flow rates of the injected and discharged reaction gases can be uniformly distributed. In contrast, if the pitch C of the support gasket lines falls below the lower limit or exceeds the upper limit of the range described above, deformation may occur in the manifold inlet and outlet holes 114, or a gap may form in the middle of the sub-gasket lines and allow the reaction gases and cooling water to flow through the gap, making it difficult to ensure airtightness.

In yet another example, the support gasket lines 123 may satisfy General Formula 3 below:

$$B - ( B \times 0.2 ) \leq A \leq B + ( B \times 0.2 ) \qquad [ General Formula 3 ]$$

In General Formula 3 above, A denotes the width of the support gasket line, and B denotes the width of the manifold gasket line.

That is, the width A of the support gasket line is 0.8 to 1.2 times the width B of the manifold gasket line. Specifically, the width A of the support gasket line may be 0.9 to 1.1 times the width B of the manifold gasket line. By ensuring that the width A of the support gasket line satisfies the range described above, the deformation of the manifold inlet and outlet holes 114 can be prevented, airtightness can be ensured at the same time, and the flow rates of the injected and discharged reaction gases can be uniformly distributed. In contrast, if the width A of the support gasket line falls below the lower limit or exceeds the upper limit of the range described above, deformation may occur in the manifold inlet and outlet holes 114, or a gap may form in the middle of the sub-gasket lines and allow the reaction gases and cooling water to flow through the gap, making it difficult to ensure airtightness.

In still another example, the thickness of the support gasket lines 123 can be controlled according to the material properties of the gas diffusion layer described later and is thus not particularly limited.

In addition, the plurality of support gasket lines 123 may extend from the manifold gasket lines 121 located on the inner perimeter of each of the one or more pairs of first reaction gas manifolds 1131 toward the reaction flow path 1111 or toward the one or more pairs of first reaction gas manifolds 1131, thereby forming an additional plurality. As the plurality of support gasket lines 123 has an additional plurality formed at the positions described above, the deformation of the manifold inlet and outlet holes 114 can be prevented when stacking a fuel cell described later.

In one example, the metal separator may further include a metal coating layer (not shown) or surface modification layer (not shown) formed on the surface of the metal separator body 11, or on the surface of the metal separator body 11 on which the gasket lines 12 are formed. Specifically, if the metal coating layer or surface modification layer is formed before forming the gasket lines 12 on the metal separator body 11, the manufactured metal separator may have the metal coating layer or surface modification layer formed only on the surface of the metal separator body 11. In contrast, if the metal coating layer or surface modification layer is formed after forming the gasket lines 12 on the metal separator body 11, the manufactured metal separator may have the metal coating layer or surface modification layer formed on the surface of the metal separator body 11 on which the gasket lines 12 are formed. The metal separator can ensure excellent corrosion resistance and electrical conductivity by further including the metal coating layer or surface modification layer formed on the surface described above.

In this case, the metal coating layer may include one or more precious metal particles and a passive film formed between the one or more precious metal particles.

For example, the precious metal particles 1231 may be one or more selected from gold (Au), silver (Ag), platinum (Pt), palladium (Pd), rhodium (Rh), ruthenium (Ru), and iridium (Ir). By including the precious metal particles described above, the metal coating layer can ensure excellent corrosion resistance and electrical conductivity.

The passive film may be formed on the surface of the metal separator body 11 where the precious metal particles are not in contact with one or more of the precious metal particles, or on the surface of the metal separator body 11 on which the gasket lines 12 are formed. By having the passive film formed at the location described above, oxygen can be prevented from penetrating the interior of the metal separator body 11 on which the passive film is formed, thereby preventing rust occurrence.

In one example, the thickness of the passive film may be smaller than the length in the thickness direction of the precious metal particles. By having the thickness of the passive film smaller than the length in the thickness direction of the precious metal particles, excellent corrosion resistance and electrical conductivity can be ensured.

Furthermore, if the metal separator body 11 is made of stainless steel containing chromium and if the surface of the metal separator body 11 is exposed to the outside, a very thin Cr₂O₃ passive film with a thickness of 1 nm to 5 nm may be naturally formed on the surface, and a surface modification layer may be formed by modifying the passive film. In this case, the physical properties of each component contained in the metal separator body 11 are known in the art and will therefore be omitted.

The present application also relates to a fuel cell. The fuel cell relates to a fuel cell including the metal separator described above, and specific details of a metal separator to be described below will be omitted as the content described in the metal separator above can be applied in the same manner.

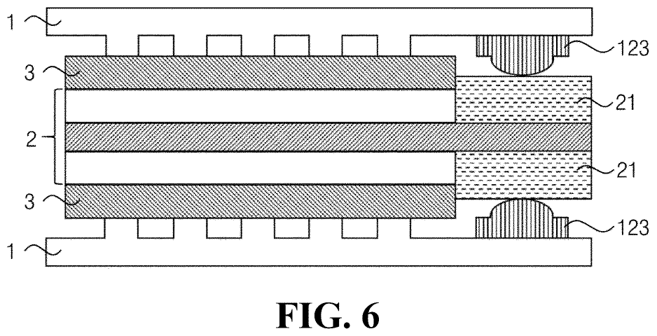

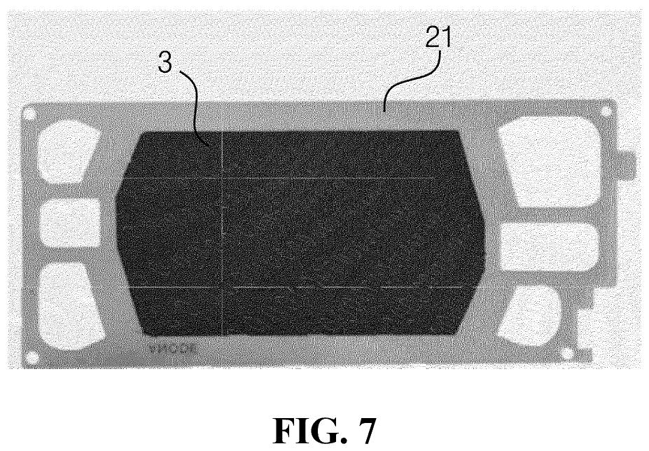

FIG. 6 is a side view showing, by way of example, a fuel cell in accordance with one embodiment of the present application. Further, FIG. 7 is a top view showing, by way of example, a fuel cell before metal separators are stacked according to one embodiment of the present application. As shown in FIG. 6, the fuel cell includes a membrane electrode assembly 2 and a pair of the metal separators 1 described above. By including a pair of the metal separators described above, the fuel cell can prevent the deformation of the manifold inlet and outlet holes during stacking and simultaneously ensure airtightness.

The membrane electrode assembly 2 is an assembly in the form of a film that serves to induce chemical reactions of the reaction gases supplied from the metal separators and convert them into electrical energy, and its outer periphery is surrounded by sub-gasket lines 21. The description that the outer periphery is surrounded herein means that the outer perimeter positioned in the direction perpendicular to the stacking direction is surrounded. In this case, any type known in the art may be used as the membrane electrode assembly 2 without particular limitation, provided its outer periphery is surrounded by the sub-gasket lines 21.

A pair of metal separators 1 is stacked, respectively, so that the sub-gasket lines 21 come in contact with the support gasket lines 123 and the reaction surfaces 111 face the lower and upper portions of the membrane electrode assembly 2. At this time, when the support gasket lines 123 formed on the reaction surface 111 of each of the pair of metal separators 1 come in contact with the sub-gasket lines 21, the support gasket lines 123 formed on the reaction surface 111 of each of the pair of metal separators 1 may be arranged to face each other.

Furthermore, in the fuel cell, the metal separator 1 disposed below the membrane electrode assembly 2 may be a hydrogen electrode metal separator, and the metal separator 1 disposed above the membrane electrode assembly 2 may be an air electrode metal separator.

In this case, the hydrogen electrode metal separator may have the gasket lines 12 formed on the surface of the reaction surface 111 of the metal separator body 11 but may not have the gasket lines 12 formed on the surface of the cooling surface 112, or may have the gasket lines 12 formed on the surfaces of the reaction surface 111 and the cooling surface 112 of the metal separator body 11.

Furthermore, the air electrode metal separator may have the gasket lines 12 formed on the surfaces of the reaction surface 111 and the cooling surface 112 of the metal separator body 11, or may have the gasket lines 12 formed on the surface of the reaction surface 111 of the metal separator body 11 but may not have the gasket lines 12 formed on the surface of the cooling surface 112.

That is, even if the gasket lines 12 are formed on the surface of the cooling surface 112 included in the hydrogen electrode metal separator but the gasket lines 12 are not formed on the surface of the cooling surface 112 included in the air electrode metal separator, or even if the gasket lines 12 are formed on the surface of the cooling surface 112 included in the air electrode metal separator but the gasket lines 12 are not formed on the surface of the cooling surface 112 included in the hydrogen electrode metal separator, the airtightness of the cooling surface 112 can be ensured when stacking the fuel cell as a unit cell.

In one example, the fuel cell may further include a pair of gas diffusion layers 3, each provided between each of the pair of metal separators 1 and the membrane electrode assembly 2, as shown in FIGS. 6 and 7. In this case, any type known in the art may be used as the gas diffusion layer 3 without limitation, and there is no particular restriction.

The present application also relates to a fuel cell stack. The fuel cell stack relates to a fuel cell stack including the fuel cell described above as a unit cell, and specific details of a fuel cell to be described below will be omitted as the content described in the fuel cell above can be applied in the same manner.

As described above, the fuel cell stack includes the fuel cell as a unit cell. By including the fuel cell described above as a unit cell, the fuel cell stack can prevent the deformation of the separators during stacking and ensure airtightness.

### DESCRIPTION OF REFERENCE SYMBOLS

1: Metal separator
11: Metal separator body
111: Reaction surface
1111: Reaction flow path
112: Cooling surface
1121: Cooling flow path
113: Manifold part
1131: First reaction gas manifold
1132: Cooling water manifold
1133: Second reaction gas manifold
114: Manifold inlet and outlet holes
115: Diffusion flow path
12: Gasket line
121: Manifold gasket line
122: Flow path gasket line
123: Support gasket line
2: Membrane electrode assembly
21: Sub-gasket line
3: Gas diffusion layer
A: Width of support gasket line
B: Width of manifold gasket line
C: Pitch of support gasket lines
D: Length of support gasket line

What is claimed:

1. A metal separator comprising a metal separator body and gasket lines formed on a surface of one or more faces of the metal separator body,
wherein the metal separator body comprises:
a reaction surface including a reaction flow path;
a cooling surface located opposite the reaction surface and including a cooling flow path;
a manifold part including one or more pairs of first reaction gas manifolds, one or more pairs of cooling water manifolds, and one or more pairs of second reaction gas manifolds formed by passing through the reaction surface and the cooling surface on both sides of each of the reaction flow path and the cooling flow path; and
a plurality of manifold inlet and outlet holes formed by passing through the reaction surface and the cooling surface between the one or more pairs of second reaction gas manifolds and each of the reaction flow path and the cooling flow path,
wherein the gasket lines comprise:
manifold gasket lines respectively surrounding an entire perimeter of each of the one or more pairs of first reaction gas manifolds, the one or more pairs of cooling water manifolds, and the one or more pairs of second reaction gas manifolds, or respectively surrounding an entire perimeter of each of the one or more pairs of first reaction gas manifolds and the one or more pairs of second reaction gas manifolds;
flow path gasket lines connected to the manifold gasket lines, and surrounding the reaction flow path and the plurality of manifold inlet and outlet holes or surrounding the cooling flow path and the one or more pairs of cooling water manifolds; and
a plurality of support gasket lines extending from the manifold gasket lines located on an inner perimeter of each of the one or more pairs of second reaction gas manifolds toward the reaction flow path or each of the one or more pairs of second reaction gas manifolds and formed between the plurality of manifold inlet and outlet holes, and
wherein the support gasket lines satisfy General Formula 1 below:
$$( B - ( B \times 0.5 ) ) 2 \leq D \leq ( B + ( B \times 0.5 ) ) 2 \qquad [ General Formula 1 ]$$
where, in General Formula 1 above, D is a length of the gasket line, and B is a width of the manifold gasket line.

2. The metal separator of claim 1, wherein the manifold gasket lines have a width of 2 mm to 5 mm.

3. The metal separator of claim 1, wherein the gasket lines comprise fluorocarbon rubber (FKM), ethylene propylene diene terpolymer (EPDM), or vinyl methyl silicone rubber (LSR).

4. The metal separator of claim 1, wherein the plurality of support gasket lines extends from the manifold gasket lines located on an inner perimeter of each of the one or more pairs of first reaction gas manifolds toward the reaction flow path or each of the one or more pairs of first reaction gas manifolds, thereby forming an additional plurality.

5. The metal separator of claim 1, wherein the gasket lines are formed on the surfaces of the reaction surface and the cooling surface of the metal separator body, or are formed on the surface of the reaction surface of the metal separator body but not on the surface of the cooling surface.

6. The metal separator of claim 1, wherein the metal separator body is a base material made of stainless steel, titanium, aluminum, magnesium, or an alloy thereof.

7. The metal separator of claim 1, wherein the metal separator body further comprises diffusion flow paths connected to each of the reaction flow path and the cooling flow path and extending toward the plurality of manifold inlet and outlet holes.

8. The metal separator of claim 7, further comprising:
a metal coating layer or surface modification layer formed on a surface of the metal separator body or on a surface of the metal separator body on which the gasket lines are formed.

9. A fuel cell comprising:
a membrane electrode assembly whose outer periphery is surrounded by sub-gasket lines; and
a pair of the metal separators according to claim 1 stacked, respectively, such that the sub-gasket lines come in contact with the support gasket lines and the reaction surfaces face lower and upper portions of the membrane electrode assembly.

10. The fuel cell of claim 9, wherein the metal separator disposed below the membrane electrode assembly is a hydrogen electrode metal separator, and
the metal separator disposed above the membrane electrode assembly is an air electrode metal separator.

11. The fuel cell of claim 10, wherein the hydrogen electrode metal separator has the gasket lines formed on the surface of the reaction surface of the metal separator body but no gasket lines formed on the surface of the cooling surface, or has the gasket lines formed on the surfaces of the reaction surface and the cooling surface of the metal separator body, and
the air electrode metal separator has the gasket lines formed on the surfaces of the reaction surface and the cooling surface of the metal separator body, or has the gasket lines formed on the surface of the reaction surface of the metal separator body but no gasket lines formed on the surface of the cooling surface.

12. A fuel cell stack comprising the fuel cell according to claim 9 as a unit cell.
